(19) United States
(12) Patent Application Publication
(10) Pub. No.: US 2012/0219375 A1
(43) Pub. Date: Aug. 30, 2012

(54) Tool holder, and tool system with a tool holder and a tool

(75) Inventors: Uwe Hobohm, Wendelstein (DE); Heinrich Georg Manner, Guteneck (DE); Werner Zitzmann, Wernberg-Koblitz (DE)

(73) Assignee: KENNAMETAL INC., Latrobe, PA (US)

(21) Appl. No.: 13/397,651

(22) Filed: Feb. 15, 2012

(30) Foreign Application Priority Data
Feb. 24, 2011 (DE) 102011012144.7-14

(51) Int. Cl. B23C 5/26

(52) U.S. Cl. 409/234

(57) ABSTRACT

The tool holder (2) is realized for fastening to a machine tool and for reversibly receiving a radial tool (4), in particular for receiving a milling cutter. The tool holder (2) is realized in three parts, having a rear machine part (6), made of a ductile elastic tool steel, for reversibly fastening to the machine tool, and having a front clamping part (10), made of a tool steel, for reversibly receiving the tool (4), and having an intermediate part (8), made of a heavy metal, in particular solid hard metal, disposed between the machine part (6) and the clamping part (10). Owing to the greater density of the heavy metal in comparison with the tool steel, the tool holder (2) is better able to absorb forces occurring during a milling operation, thereby achieving a milling operation that is sparing of the cutting tool, and consequently achieving a long service life.

### BACKGROUND OF THE INVENTION

1. Field of the Invention

The invention relates to a tool holder having the features of the preamble of claim 1, and to a tool system comprising a tool holder and a tool.

2. Description of Related Art

Such a tool holder, in particular for receiving a ball shank milling cutter, is known, for example, from WO 2008/116446 A1. Milling cutters, in particular ball shank milling cutters, are often used to produce groove-shaped races, this being, in the case of ball shank milling cutters, to produce so-called ball races. A special application is to be found in the field of wheel suspension in automobiles, to enable an articulated wheel fastening to be achieved. The ball race in such cases is made on a circumferential side of a cylindrical component, traversing the latter. Owing to the high numbers of pieces in this case, a high process speed with high quality is sought.

Particularly in the case of milling operations, in which a radial advance motion is effected, large forces occur, which must be absorbed by the tool holder. Inadequate guiding of the tool by the tool holder leads to unsatisfactory machining results or to premature wearing of the tool.

The tool holder known from WO 2008/116446 comprises a rear coupling portion for reversibly fastening to a machine tool. At its front end, the tool holder has a clamping part for receiving the actual tool, which is connected to the rest of the tool holder via a pin connection. This clamping part is composed of a tool steel, and serves to receive a ball shank milling cutter composed of solid hard metal. In an alternative variant, the clamping part itself is likewise made from solid hard metal.

### SUMMARY OF THE INVENTION

Proceeding from this, the invention is based on the object of specifying a tool holder, in particular for a milling cutter, that exhibits an improved capacity to absorb force, and that enables the tool to be operated in a more sparing manner and is thereby instrumental in the tool having a longer service life.

The object is achieved, according to the invention, by a tool holder having the features of claim 1. The tool holder in this case extends generally in an axial direction, and is realized with a rear coupling portion for fastening to a spindle of a machine tool. At its front end, it is realized for reversibly receiving a rotating tool, in particular for reversibly receiving a milling cutter, in particular a ball head milling cutter. The respective rotating tool in this case has a circular clamping shank, which is clamped in a highly precise manner in the tool holder. The tool holder itself is realized in three parts, having a rear machine part, made of an, in particular, ductile elastic tool steel, and having a front clamping part, made of a preferably likewise ductile elastic tool steel, and having an intermediate part, made of a heavy metal, disposed between the machine part and the clamping part. The machine part comprises the rear coupling portion for reversibly fastening to the machine tool, and the clamping part serves to reversibly fasten the clamping shank of the tool in the tool holder. Heavy metal in this case is understood generally to mean that the intermediate part is made of a metal having a greater density than the tool steel for the machine part and for the clamping part.

The heavy metal is preferably a (sintered) material produced by powder metallurgy, in particular a solid hard metal.

This design is based on the consideration that, particularly in the case of milling operations, large forces, in particular also force impulses, occur, which have to be absorbed by the tool holder. This is achieved in that an intermediate piece is made from a heavy metal, since, owing to the greater density, such forces, in particular force peaks, are better absorbed in comparison with conventionally designed tool holders. In particular, the disposition of the intermediate piece made from heavy metal better prevents vibration of the system as a whole, such that, overall, an improved concentricity is achieved, this being significantly instrumental in achieving a lesser tool wear, and consequently a longer service life.

For high-precision workpiece machining by removal of metal with, at the same time, a high cutting rate, tools made of solid hard metal are preferably used, owing to their resistance to wear.

Because the clamping part is made from a tool steel, in particular hot-work steel, having a greater elasticity (less brittleness) than the heavy metal, it can at the same time be achieved and ensured that the clamping shank of the tool itself is clamped in a sparing manner. Owing to the ductile elastic realization of the clamping part, the direct connection point between the tool holder and the tool itself is therefore to some extent tolerant in respect of force peaks in particular, such that, overall, a comparatively sparing clamping of the tool is ensured. At the same time, the force peaks are reliably and safely absorbed by the tool holder, owing to the intermediate piece made of heavy metal.

The density of the heavy metal in this case is, for example, in the range between 12 and 18 g/cm³, whereas the density of the tool steel for the clamping part and for the machine part is typically only in the range of up to 10 g/cm³. The material of the machine part and of the clamping part is preferably a so-called hot-work steel such as, for example, a high-speed steel (HS steel).

According to a preferred design, the material volume of the intermediate part is greater than that of the clamping part, in particular by more than twofold greater, or corresponds approximately to 1.5 to 3 times the volume of the clamping part. The intermediate part therefore has a comparatively large material volume, such that forces, vibrations, etc. can be reliably absorbed.

In an expedient design, the intermediate part is irreversibly connected to the machine part, preferably by a material bond fastening, in particular by a soldered connection. An irreversible connection in this case is understood to mean that the connection cannot be separated again without destroying it.

As an alternative or as a supplement to the soldered connection, the intermediate part is expediently screwed, with a fastening shank, into the machine part. For supplemental securing against loss, or in order to prevent the screwed connection from becoming undone, an adhesive bonded connection is provided in addition in the thread region.

Expediently, the intermediate part is realized with the fastening shank and a head region, the head region being provided, on its underside, with an annular surface, which, in particular, is realized so as to be conical and by which the intermediate part bears flatly and with a precise fit on a corresponding end face of the intermediate part. Owing to the conical design, a centering function is achieved.

The clamping part is preferably realized as an exchangeable (wearing) part, and is therefore reversibly fastened in the intermediate part. This enables the full functionality of the tool holder to be restored in a simple and inexpensive manner in the event of damage to the clamping part, without the need for a new replacement for the entire tool holder.

For this purpose, expediently, the clamping part is screw-connected to the intermediate part, in particular screwed into the latter. For this purpose, expediently, the clamping part has a tool engagement means for fastening to the intermediate part. In particular, for this purpose the circumferential side of the clamping part is realized with engagement surfaces for a tool key having a defined key width.

Supplementally, in an expedient development, the clamping part is additionally adhesive-bonded to the intermediate part to secure against loss. This prevents the screwed connection from becoming progressively undone as a result of the vibrations that occur. The adhesive connection in this case is selected in such a way, however, that the clamping part can be unscrewed from the intermediate part without destroying it.

In order to ensure that force is introduced into the intermediate part in a reliable manner, the clamping part is fastened, at least in regions thereof, in particular by a fastening foot, in a pot-shaped receiver of the intermediate part. The clamping part is therefore surrounded, at least in its foot region (fastening foot), by heavy metal around its entire circumference. The foot region in this case preferably extends over at least 50% of the total length of the clamping part in the axial direction.

The clamping part bears by its head region, preferably by a circumferential, in particular conically tapering, further annular surface, with a precise fit on a further end face of the intermediate part, which end face is realized to correspond to said annular surface.

Expediently, the clamping part is realized generally as a (hollow) cylindrical sleeve, which, in addition to the fastening foot, has a receiver for the tool. The hollow cylindrical design provides for a central supply of coolant.

In a preferred design, it is therefore also provided that the intermediate part has a continuous coolant channel, which opens into the clamping part. A suitable coupling point is realized in the clamping part, for the purpose of introducing coolant into the tool.

The region of the clamping part that projects over the intermediate part is preferably in alignment with the outer wall of the intermediate part, i.e. the intermediate part and the clamping part have the same outer diameter at their point of separation.

The intermediate part itself in this case is realized so as to taper cylindrically or conically towards the clamping part.

Such a tool holder is used, expediently, for milling operations, i.e. is preferably equipped with a milling cutter.

The object is furthermore achieved, according to the invention, by a tool system having the features of claim 13. According to the latter it is provided, in a preferred design, that the tool holder is used in combination with a two-part tool, the tool having a clamping shank, made of a tool steel, and having a cutting part, made of solid hard metal, which is connected to the clamping shank.

In particular, combining the specially realized tool holder with such a specially realized tool, in particular a milling tool, preferably a ball race milling cutter, leads to considerably improved machining results, particularly in longer service lifetimes and in improved workpiece quality.

The tool preferably has the features according to claim 14. The tool used is, in particular, a tool such as that described in the German patent application entitled “Milling cutter, in particular ball shank milling cutter”, which has been submitted by the applicant at the same time as the present application. To that extent, reference is made to the full scope of the content of this parallel application.

### BRIEF DESCRIPTION OF THE DRAWINGS

An exemplary embodiment of the invention is explained more fully in the following with reference to the drawings, wherein:

FIG. 1 shows a side representation of a tool holder with an inserted ball shank milling cutter,

FIG. 2 shows a sectional representation of the tool holder according to FIG. 1, without the inserted ball shank milling cutter,

FIG. 3 shows a perspective representation of the ball shank milling cutter inserted in the tool holder.

### DETAILED DESCRIPTION OF THE INVENTION

In the figures, equivalent parts are denoted by the same references.

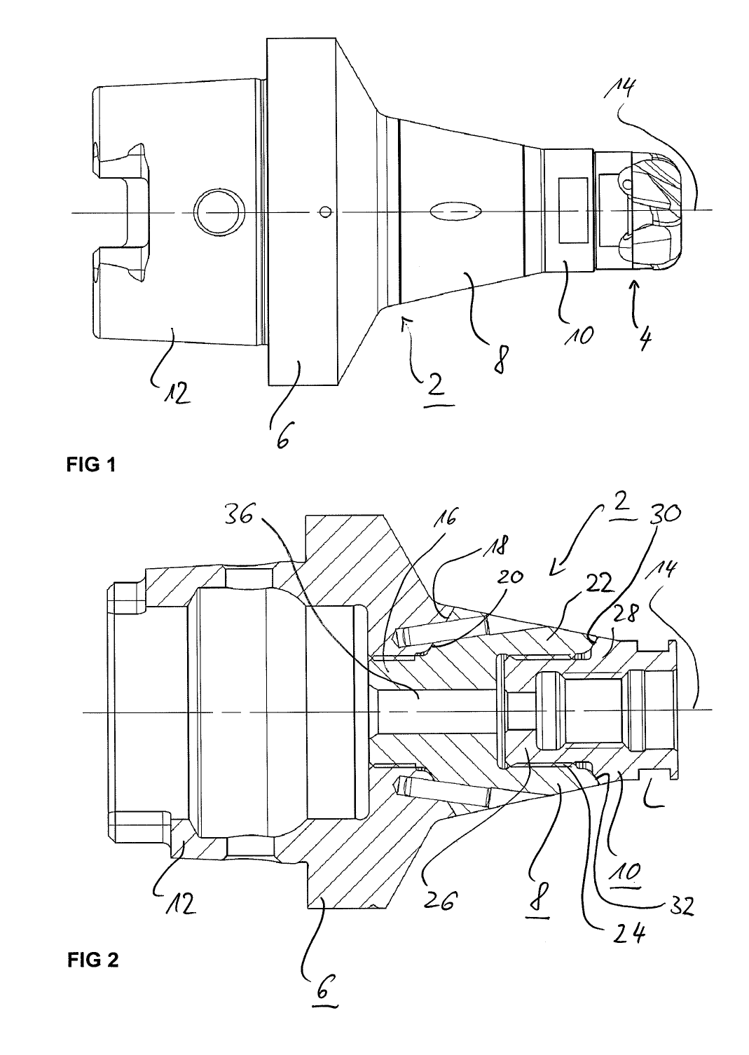

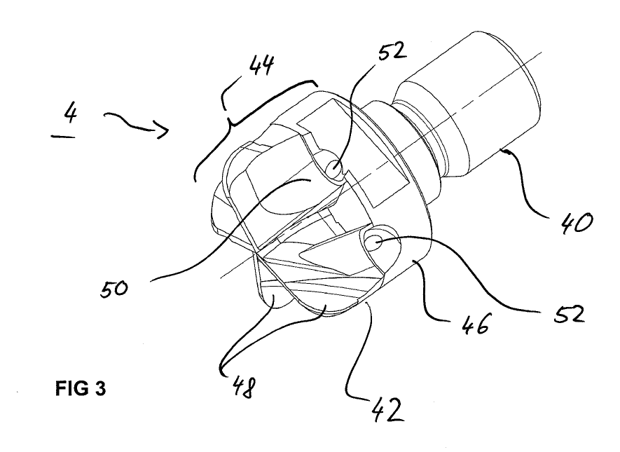

The tool holder 2 represented in FIGS. 1 and 2 is used, in particular, in combination with the special ball shank milling cutter, represented in detail in FIG. 3, for machining with removal of metal, in particular in the field of automobiles, for producing ball races to enable an articulated wheel suspension to be achieved. The tool holder 2 and the ball milling cutter 4 therefore constitute a tool system in which each is matched to the other.

The products in this case are mass-produced products, and a good quality of machining is required, with short process times. During the machining, high loads occur, which can result in vibrations that can lead to premature tool wear and also to a lesser quality of machining. The tool holder 2 described in the following, in particular in combination with the ball shank milling cutter 4 represented in FIG. 3, makes it possible to achieve a high quality of processing, with longer service lifetimes, compared with systems being used at present.

The tool holder 2 in this case is realized in three parts, and has a rear machine part 6, an intermediate part 8 and a front piece, realized as a clamping part 10. The machine part 6, in its rear part, has a coupling portion 12, which, in the exemplary embodiment, is an HSK coupling, by which the tool holder 2 can be reversibly fastened to a spindle of a machine tool.

The entire tool holder 2 extends in the direction of a longitudinal axis 14, which, at the same time, defines an axis of rotation, about which the tool holder 2 rotates during machining. The tool holder 2 and the individual components are realized so as to be rotationally symmetrical in relation to the longitudinal axis 14, and have a circular cross-section.

The machine part 6 and the clamping part 10 are made from a tool steel, whereas the intermediate piece 8 is composed of a heavy metal, in particular a hard metal. The intermediate piece 8 therefore has a greater density in comparison with the two other parts 6, 10. The forces and vibrations that occur during the machining process are absorbed in an effective manner, in particular because of the greater density of the intermediate piece 8.

The intermediate piece 8 has a fastening shank 16, by which it is fastened into a corresponding receiver on the machine part 6. In the exemplary embodiment, a screwed connection is provided for this purpose. The fastening shank 16 therefore has an outer thread, and the associated receiver of the machine part 6 has an inner thread. To secure against loss, it is additionally provided that the intermediate piece 8, in the region of the fastening shank 16, i.e. in the threaded region, is adhesive-bonded to the machine part 6. As an alternative or supplement to this type of connection, the intermediate piece 8 is irreversibly and non-detachably connected to the machine part 6 by a material bond fastening, in particular by being soldered on.

The intermediate piece 8 itself has, adjoining its fastening shank 16, a conically inclined annular surface 18, by which the intermediate piece 8 bears flatly on an associated end face 20 of the machine part 6. This design ensures that the intermediate piece 8 is fastened to the machine part 6 with a highly precise fit and, in particular, it is thereby ensured that the respective center axes of the machine part 6 and of the intermediate piece 8 are in highly precise alignment with one another, such that a highly precise concentricity is ensured.

Adjoining the fastening shank 16 in the direction of the longitudinal axis 14 there is a head region 22, which, in its front region, has a pot-shaped receiver 24, in which the clamping part 10 is fastened. The head region 22 itself, with its peripheral surface side, is in alignment with the associated outer surfaces of the machine part 6. The head region 22 tapers conically towards the clamping part 10.

The clamping part 10 itself is similar in its realization to the intermediate piece 8, and has a fastening foot 26, which carries an outer thread. The clamping part 10 is screwed into the pot-shaped receiver 24 by means of the fastening foot 26. Supplementally, the thread is adhesive-bonded to secure against loss. Also, adjoining the fastening foot 26, the clamping part 10 has a head part 28, realized on the underside of which there is a further annular surface 30, which is likewise realized so as to be conical. By means of this further annular surface 30, the clamping part 10 bears flatly on a corresponding further end face 32 of the intermediate part 8. The peripheral surface of the head part 28, in turn, is in alignment with the peripheral surface of the intermediate piece 8.

The further end face 32 in this case is preferably oriented at an angle in the range from 25 to 40°, in particular in the region of approximately 30° in relation to a transverse plane. A transverse plane is understood to mean a plane in relation to which the longitudinal axis 14 forms the perpendicular.

In the exemplary embodiment, the head part 28 has a tool engagement means 34, namely, flattened surfaces having a defined key width, on its circumferential surface.

In addition, passing through the intermediate piece 8 there is a central cooling channel 36, which runs along the longitudinal axis 14 and which is continued in the clamping part 10. The clamping part 10 is realized correspondingly, as a whole, in the manner of a sleeve. In order to ensure a secure and reliable supply of coolant to the tool 4, corresponding coupling interfaces are provided.

The clamping part 10 serves generally to receive a clamping shank 40 of the tool 4, in particular to receive a cylindrical clamping shank 40. The latter is preferably held in a clamping manner in the clamping part 10. The clamping part 10 defines to that extent a so-called chuck for the clamping shank 40. In the exemplary embodiment, the tool 4 is designed to be screw-fastened in the clamping part 10. As an alternative to this, the clamping part 10 can also be realized for other types of fastening, for example for fastening by clamping.

The tool holder 2 is used, in particular, in combination with a special tool 4, which is distinguished by a two-part design. The special construction is shown, by way of example, by the ball shank milling cutter 4 represented in FIG. 3. This ball shank milling cutter 4 comprises, in general, a cutting part 42 of solid hard metal, which is connected to the clamping shank 40 by a material bond, in particular by soldering, and in an irreversible manner. The clamping shank 40 is composed of a tool steel, in particular hot-work steel, which has a considerably greater ductile elasticity than the comparatively brittle solid hard metal.

In particular, it is provided in this case that the tool 4 has a tool head 44, which adjoins the clamping shank 40 and which comprises a carrier part 46 and the cutting part 42 fastened thereto. The carrier part 46 and the clamping shank 40 together constitute a single structural unit, which is realized, for example, by machining with removal of material from a single-piece workpiece of a conventional tool steel. The cutting part 42 is fastened to the carrier part 46 by soldering. The single-piece component consisting of the clamping shank 40 and the carrier part 46 is realized—as viewed in a side view—approximately in the form of a T. The cutting part 42 sits flatly on the front end side of the carrier part 46, and can have a centering pin for the purpose of centering.

The cutting part 42 has a plurality of cutting teeth 48, realized between each of which there are clearances that comprise chip flutes 50. At their ends, the chip flutes 50 are continued into the carrier part 46. Opening into these chip flutes 50 in the carrier part 46 there are orifices 52 of coolant channels, not represented in greater detail here. The cutting part 42 itself, which is composed of solid hard metal, does not have coolant channels etc. of any kind.

The tool holder 2 described here, in particular with the specially realized ball shank milling cutter 4 represented in FIG. 3, constitutes a tool system comprising a special tool holder 2 and a special tool 4, which can be used, in particular, to mill ball races in a reliable process and with a high quality of machining and at a high cutting rate. Despite the high cutting rate, a milling operation is achieved that is sparing of the tool, and consequently a long service life is achieved.

1. A tool holder for fastening to a machine tool and for reversibly receiving a rotary tool comprising a rear machine part made of a tool steel for reversibly fastening to the machine tool, a front clamping part made of a tool steel for reversibly receiving the tool, and an intermediate part made of a heavy metal disposed between the machine part and the clamping part.

2. The tool holder as claimed in claim 1, wherein the heavy metal is a material produced by powder metallurgy.

3. The tool holder as claimed in claim 1, wherein the density of the heavy metal is in the range between 12 and 18 g/ccm.

4. The tool holder as claimed in claim 1, wherein the material volume of the intermediate part is greater than that of the clamping part.

5. The tool holder as claimed in claim 1, wherein the intermediate part is fastened to the machine part by a screwed connection and/or by a material bond.

6. The tool holder as claimed in claim 1, wherein the intermediate part has a fastening shank at least partially disposed in a receiver in the machine part and having an annular surface that bears with a precise fit against an end face of the machine part.

7. The tool holder as claimed in claim 1, wherein the clamping part is an exchangeable part.

8. The tool holder as claimed in claim 7, wherein the clamping part is screw-connected to the intermediate part.

9. The tool holder as claimed in claim 8, wherein the clamping part is additionally adhesive-bonded to the intermediate part.

10. The tool holder as claimed in claim 1, wherein the clamping part has a fastening foot disposed in a pot-shaped receiver of the intermediate part and the clamping part has an annular surface that bears with a precise fit against an end face of the intermediate part.

11. The tool holder as claimed in claim 1, wherein the clamping part is a hollow cylindrical sleeve.

12. The tool holder as claimed in claim 1, wherein a coolant channel is provided through the intermediate part and opens into the clamping part.

13. A tool system comprising a tool holder as claimed in claim 1, further comprising a tool having a clamping shank made of a tool steel, and a cutting part made of solid hard metal connected thereto.

14. The tool system as claimed in claim 13, wherein the tool is a ball shank milling cutter having a tool head comprising a carrier part onto which the cutting part is fastened by a material bond, and the clamping shank together with the carrier part constitutes a single-piece component.
